(19) United States
(12) Patent Application Publication
(10) Pub. No.: US 2011/0134012 A1
(43) Pub. Date: Jun. 9, 2011

(54) HOUSING AND METHOD FOR MAKING THE SAME

(75) Inventors: Zhi-Jun Yang, Shenzhen City (CN); Mei-Wen Fu, Shenzhen City (CN); Zhan Li, Shenzhen City (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/768,695

(22) Filed: Apr. 27, 2010

(30) Foreign Application Priority Data
Dec. 3, 2009 (CN) 200910310833.7

(51) Int. Cl. H01Q 1/40; B29C 45/14

(52) U.S. Cl. 343/873; 264/272.15

(57) ABSTRACT

A housing includes a first main body, a second main body, and a antenna. The second main body is attached to the first main body. The antenna is formed between the first main body and the second main body by an injection molding process. The antenna is partially exposed from the first main body and the second main body to form a terminal. The present disclosure further discloses a method for making the housing.

### BACKGROUND

1. Technical Field

The present disclosure relates to housings and methods for making the housings, particularly, to method for making housings used in electronic devices that include an antenna.

2. Description of Related Art

Portable electronic devices, such as mobile phones, personal digital assistants (PDAs) and laptop computers are widely used. Most of these portable electronic devices have antenna modules for receiving and sending wireless signals. A typically antenna module includes carrier and an antenna layer attached on the carrier.

However, the antenna layer is exposed from the carrier and may be easily damaged. Thus, the performance of the antenna modules may be influenced.

Therefore, there is a room for improvement within the art.

### BRIEF DESCRIPTION OF THE DRAWINGS

Many aspects of a housing and method for making the housing can be better understood with reference to the following drawings. The components in the drawings are not necessarily to scale, the emphasis instead being placed upon clearly illustrating the housing and method for making the housing. Moreover, in the drawings, like reference numerals designate corresponding parts throughout the several views.

FIG. 1 is an isometric view of an exemplary housing used in an electronic device.

FIG. 2 is an exploded view of the partial housing showing in FIG. 1.

FIG. 3 is an isometric view of an antenna formed on a first main body.

FIG. 4 is a partial cross-sectional view of the housing taken along line IV-IV of FIG. 1.

### DETAILED DESCRIPTION

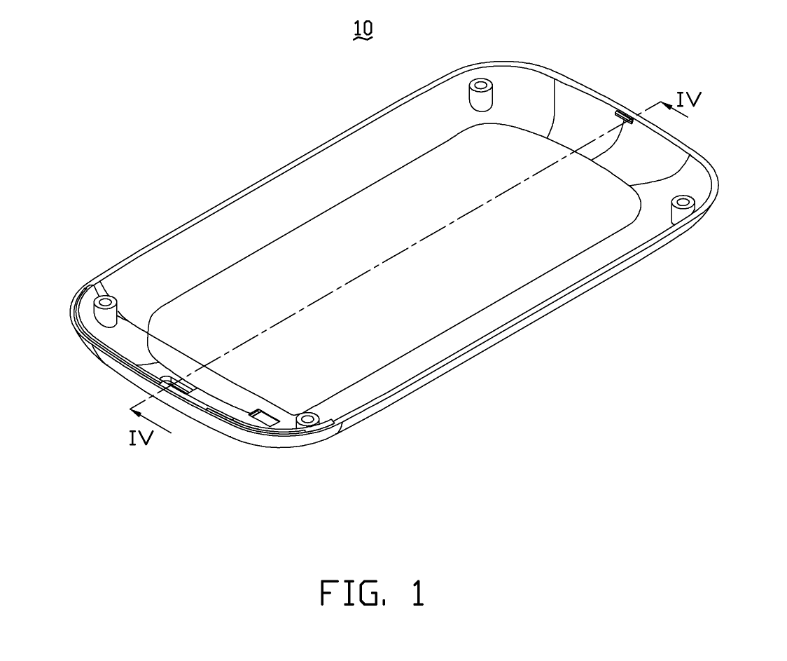

FIG. 1 shows an exemplary housing 10 used in an electronic device, such as mobile phone, or personal digital assistant.

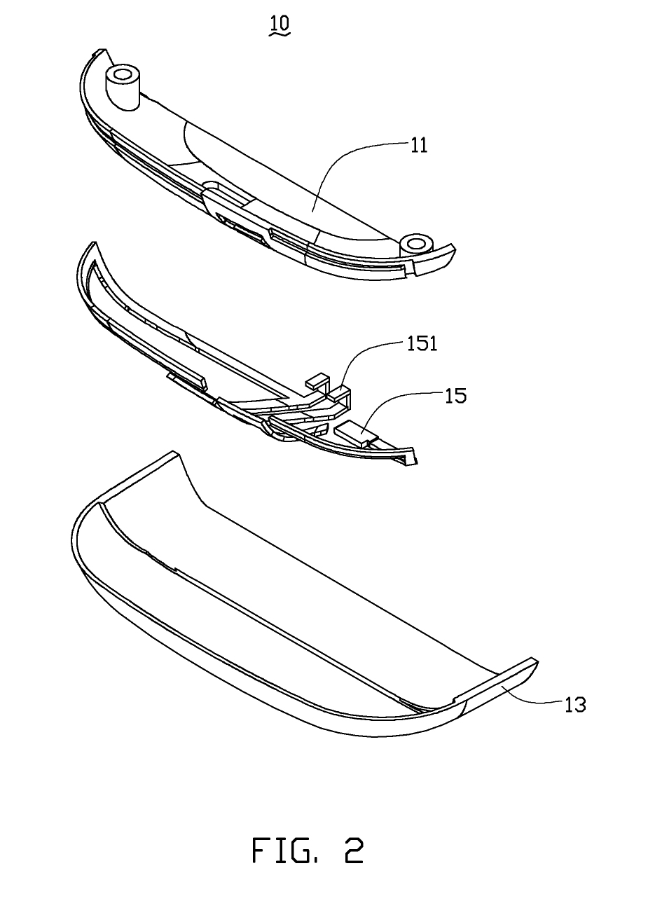

Referring to FIG. 2, the housing 10 includes a first main body 11, a second main body 13, and an antenna 15 formed between the first main body 11 and the second main body 13.

The first main body 11 can be made by an injection molding process. The first main body 11 can be made of polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, polypropylene, or any desired combination thereof. The first main body 11, according to an exemplary embodiment, is made of polycarbonate. The second main body 13 can be made by an injection molding process. The second main body 13 can be made of polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, polypropylene, or any desired combination thereof. The second main body 13, according to an exemplary embodiment, is made of acrylonitrile-butadiene-styrene and polycarbonate. An injection-molding temperature of the second main body 13 is lower than an injection-molding temperature of the first main body 11.

The antenna 15 is made of metal deformed into a tortuous shape. The antenna 15, according to an exemplary embodiment, is made of copper. The antenna 15 is formed between the first main body 11 and the second main body 13 by a double shot molding process. A terminal 151 is exposed from the first main body 11 and the second main body 13 for electronically connecting to electronic components of the electronic device.

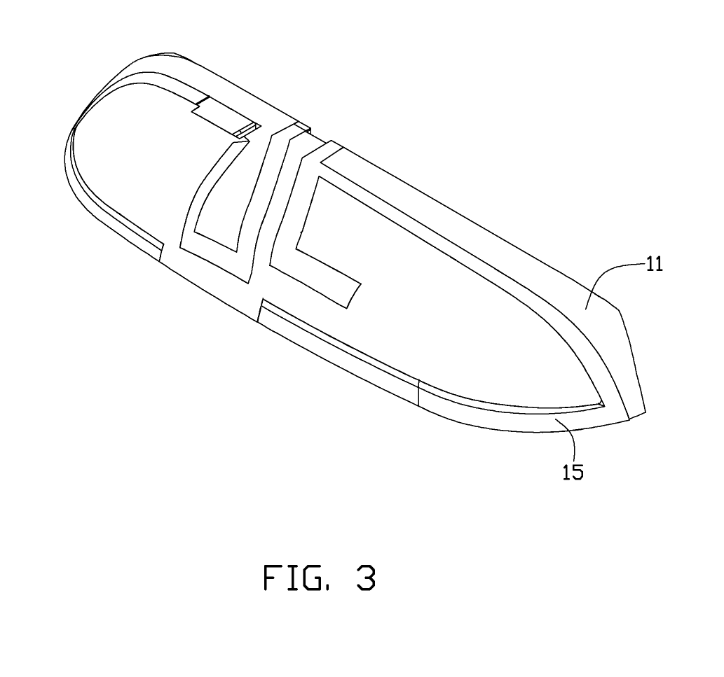

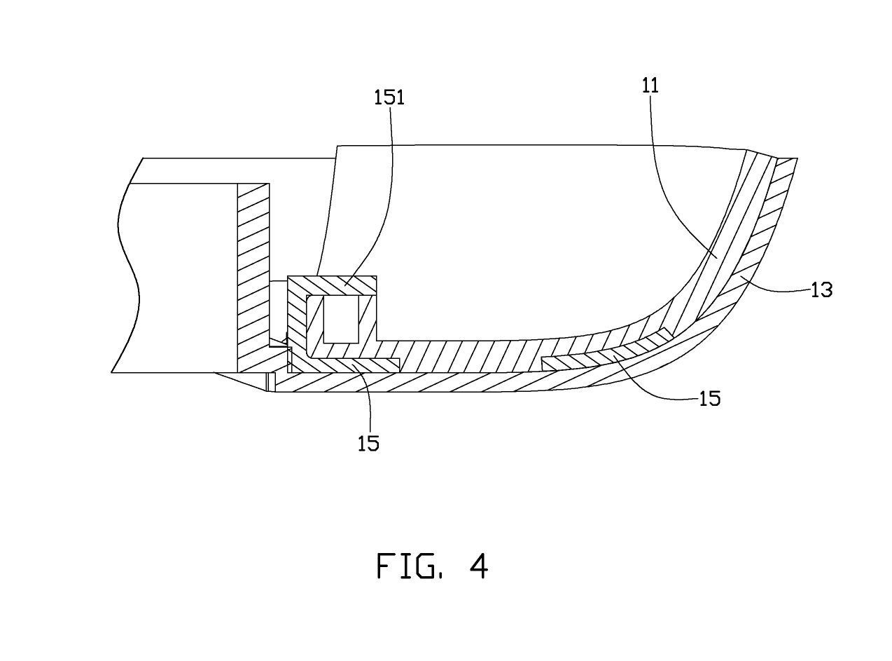

Referring to FIG. 3 and FIG. 4, an exemplary embodiment of a method for making the housing 10 may comprise the following steps:

A first injection molding machine and a second injection molding machine are provided. The first injection molding machine includes a first chamber and the second injection molding machine includes a second chamber. The antenna 15 is placed into the first chamber. Then, a material, such as polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, or polypropylene is injected into the first chamber to form the first main body 11 attached to a side of the antenna 15. The material is polycarbonate according to an exemplary embodiment.

The first main body 11 attached to the antenna 15 is placed into the second chamber. Then, molten plastic is injected into the second chamber to form the second main body 13 attached to a side of the first main body 11, and partially covering the antenna 15. Thus, the terminal 151 is exposed from the first main body 11 and the second main body 1. The plastic can be made of polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, polypropylene, or any desired combination thereof. The second main body 13 in a preferred exemplary embodiment, is made of acrylonitrile-butadiene-styrene and polycarbonate. The injection-molding temperature of the second main body 13 is lower than the injection-molding temperature of the first main body 11.

The antenna 15 is embedded in the housing 10. Thus, the housing 10 can protect the antenna 15 from being damaged. In addition, the antenna 15 can be assembled in the housing 10, thus, the working efficiency is increased.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A housing comprising:
a first main body;
a second main body attached to the first main body; and
a antenna formed between the first main body and the second main body during the injection molding processes forming the first main body and the second main body, the antenna being partially exposed from the first main body and the second main body to form a terminal.

2. The housing as claimed in claim 1, wherein the first main body and the second main body are made of one of polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, polypropylene, or any desired combination thereof.

3. The housing as claimed in claim 2, wherein an injection-molding temperature of the second main body is lower than an injection-molding temperature of the first main body.

4. The housing as claimed in claim 1, wherein the antenna is attached to a side of the main body, the second main body is attached to the side of the first main body and partially covering the antenna.

5. The housing as claimed in claim 1, wherein the first main body is made of polycarbonate.

6. The housing as claimed in claim 1, wherein the second main body is made of acrylonitrile-butadiene-styrene and polycarbonate.

7. A method for making a housing, comprising:
providing a first injection molding machine and a second injection molding machine; the first injection molding machine comprising a first chamber, the second injection molding machine comprising a second chamber;
placing a antenna into the first chamber; injecting a first injection material into the first chamber to form a first main body attached to the antenna; and
injecting a second injection material into the second chamber to form a second main body attached to the first main body and partially covering the antenna.

8. The method for making a housing as claimed in claim 7, wherein the first main body and the second main body are made of polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, polypropylene, or any desired combination thereof.

9. The method for making a housing as claimed in claim 8, wherein an injection-molding temperature of the second main body is lower than an injection-molding temperature of the first main body.

10. The method for making a housing as claimed in claim 7, wherein the antenna is attached to a side of the main body, the second main body is attached to the side of the first main body and partially covering the antenna.

11. The method for making a housing as claimed in claim 10, wherein the antenna is partially exposed from the first main body and the second main body to form a terminal.

12. The method for making a housing as claimed in claim 7, wherein the first main body is made of polycarbonate.

13. The method for making a housing as claimed in claim 7, wherein the second main body is made of acrylonitrile-butadiene-styrene and polycarbonate.

14. The method for making a housing as claimed in claim 7, wherein the antenna is made of copper.
